(19) United States
(12) Patent Application Publication
(10) Pub. No.: US 2009/0054187 A1
(43) Pub. Date: Feb. 26, 2009

(54) CHAIN DRIVE AND USE OF A CHAIN IN A CHAIN DRIVE

(75) Inventor: Rainer Pflug, Heilsbronn (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/162,822

(22) PCT Filed: Jan. 30, 2007
(86) PCT No.: PCT/EP2007/050915

§ 371 Date: Jul. 31, 2008

(30) Foreign Application Priority Data
Feb. 1, 2006 (DE) 102006004533.5

(51) Int. Cl. F16H 55/30; F16G 13/04

(52) U.S. Cl. 474/141; 474/212

(57) ABSTRACT

A chain drive is provided including a plurality of shafts (2, 4, 5), which are connected to the drive, each having one sprocket (3, 6, 7), and a chain (8) which is guided over the sprockets (3, 6, 7). At least one sprocket (3) is non-circular in order to reduce the chain forces which result from the disturbance vibrations introduced into the drive (1). The chain (8) is formed of links (9, 10, 11) which are connected to one another by pin-like connecting elements (15) and which have connection apertures (12, 13, 14), and the connection apertures (12, 13, 14) of all the links (9, 10, 11) are normally punched.

### BACKGROUND

The invention relates to a chain drive comprising several shafts integrated in the drive each with a sprocket, and a chain guided over the sprockets, wherein at least one sprocket is non-circular for reducing the chain forces resulting from disturbance vibrations introduced into the drive, wherein the chain is comprised of links, which are connected to each other by pin-like connecting elements and which have connection apertures.

Chain drives are used in the automotive field, for example, in the form of control drives for internal combustion engines. Depending on the system, such a chain drive does not run uniformly and free from vibrations, but instead disturbance vibrations are coupled into the drive via the linked shafts or generated by their associated or downstream assemblies, which lead to periodically oscillating forces and moments in the drive train. These oscillations generate local force oscillations, which are inevitably considerable and which act on the chain and which the chain must absorb, wherein the chain must be designed accordingly. Typically, in such oscillation-loaded chain drives, chains are used, in which the connection apertures of the individual links, which are penetrated by the pin-like connection element, are fine-punched. In contrast to a normally punched aperture, a fine-punched aperture is distinguished by a flush-cut portion >80%. This flush-cut portion is given from the ratio of the flush-cut length of the punch aperture given relative to the punching direction to the link thickness. The flush-cut portion should be as high as possible for receiving the high forces or the compensation of the force oscillations, in order to realize a high force transmission surface between the link and the connection element. Indeed, such fine-punched chains can be used in known chain drives despite the disturbance vibrations and the periodic changes in force. Nevertheless, their actual costs are considerable, because the production expense is very large due to the fine punching.

For example, from DE 195 20 508 A1, it is known, for reducing the disturbance vibrations, which are introduced into the drive, for example, via the crankshaft coupled with the internal combustion engine, which generates periodic force oscillations due to the piston movement, for one of the sprockets, whether it is a drive wheel, e.g., the crankshaft wheel, or a driven wheel, e.g., a camshaft wheel, or the like to have a non-round shape and to selectively introduce compensation oscillations into the drive due to this non-round, e.g., oval shape, wherein these compensation oscillations compensate the undesired disturbance vibrations, that is, they counteract these disturbance vibrations. Moreover, a certain damping of the disturbance oscillations and consequently a smoothing of the drive train can be achieved. Also, in such “smoothed” drives, fine-punched chains are used due to the still present, although damped force oscillations.

### SUMMARY

The invention is based on the objective of providing a chain drive, which has an improved design relative to previously known chain drives, especially in terms of cost.

To meet this objective, for a chain drive of the type noted above it is provided according to the invention that the connection apertures of all of the links are normally punched.

In the chain drive according to the invention—different than in the state of the art—instead of a fine-punched chain, an exclusively normally punched chain, that is, a chain with exclusively normally punched connection apertures is used. It has been emphasized, namely that through integration of one or more non-round wheels and thus the disturbance vibration damping can achieve a reduction of the periodic force oscillations to a degree that the resulting forces can be absorbed by an easily realized, exclusively normally punched chain despite the significantly reduced force transmission surface caused by the normal punching. A chain drive with one or more non-round wheels thus easily allows the use of an exclusively normally punched chain. Such a chain, however, can be produced significantly more easily and more economically, because the driving expense for the production of a normally punched connection aperture is significantly smaller than that for the production of a fine-punched connection aperture. Consequently, through the use of a normally punched chain in a chain drive at least partially smoothed by at least one non-round sprocket, a more favorable drive design can be achieved especially in terms of costs.

The chain integrated in the chain drive according to the invention can have, according to a first alternative of the invention, at each connection element, three links lying one next to the other, of which, optionally, the middle link is profiled with teeth for a force-transmitting engagement on the toothed sprocket. For this simplest chain construction, only three links are arranged on a connection element.

An alternative construction provides that the chain has five or more links lying one next to the other on each connection element, with two outer guide links, following these at least two teeth-profiled pivoting links for a force-transmitting engagement on the toothed sprocket and between these at least one, optionally similarly teeth-profiled connection link. This chain has a five, seven, or more link construction. Such a chain, which is suitable especially for use in the chain drive according to the invention, is described in the German Patent Application No. 10 2005 024 747 A1. In this patent application, it is explicitly referenced that the features described there apply equally to the present patent application as disclosed in this application. For the toothed chain described there, not only the pivoting links, but also the one or more connection link(s) has a tooth-like profile, that is, the force is transmitted not only via the pivoting links, but also via the connection link. This has the result that the entire tooth surface, which interacts with the tooth surface of the sprocket-side, contacting tooth is significantly larger than for typical toothed chains, in which the connection link has no profiling. For this chain, the entire contacting load is distributed over a larger surface, which is advantageous. This applies especially with respect to the fact that, in the chain drive according to the invention, the connection apertures of all of the links forming the chain known from DE 10 2005 024 747 are normally punched.

In addition to the chain drive according to the invention, the invention further relates to the use of a chain formed of links, which connect to each other via pin-like connection element and which have connection apertures, wherein the connection apertures of all of the links are normally punched, in a chain drive comprising several sprockets, over which the chain is guided, wherein at least one chain drive has a non-round shape. In addition, the chain that is used according to the invention has three, five, or seven links on each connection element.

### BRIEF DESCRIPTION OF THE DRAWINGS

Additional advantages, features, and details of the invention emerge from the following description of an embodiment. Shown herein are:

FIG. 1 is a block diagram of a chain drive according to the invention,

FIG. 2 is a side view of a chain that can be used in the chain drive from FIG. 1,

FIG. 3 is a partial section view through the chain cutout from FIG. 2,

FIG. 4 is an enlarged detail view of the connection region of the individual links over a connection element, and

FIG. 5 is a diagram for explaining the term “fine punching” and “normal punching.”

### DETAILED DESCRIPTION OF THE PREFERRED EMBODIMENTS

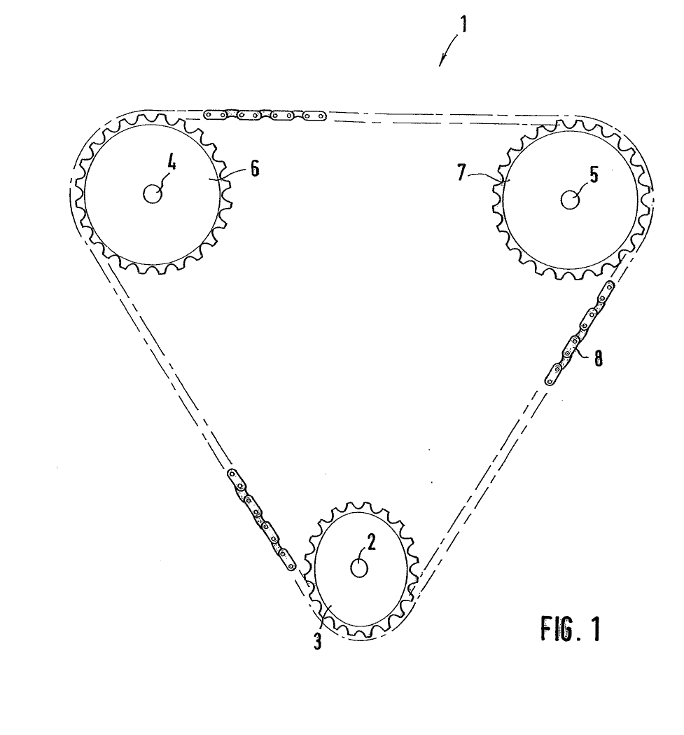

FIG. 1 shows an example chain drive 1 according to the invention, e.g., a control drive of a motor vehicle internal combustion engine. Shown is a first shaft 2, e.g., a crankshaft, on which sits a first, here non-round, oval sprocket 3. Furthermore, there are two other shafts 4, 5, e.g., two camshafts, on each of which sit round sprockets 6, 7. A chain 8 runs over all of the sprockets 3, 6, and 7. While the crankshaft 2 is directly coupled to the internal combustion engine and is driven by it, the camshafts 4, 5 are driven by the chain 8. As a result of the operation of the internal combustion engine and the piston movement, disturbance vibrations are introduced into the chain drive 1 via the crankshaft 2, which lead to periodically oscillating force, moment, and load changes on the chain 8. For smoothing these disturbance vibrations and for generating compensating counter vibrations from these disturbance vibrations, the sprocket 3 of the crankshaft 2 has a non-round construction. The basic construction of such a chain drive with at least one non-round sprocket has been known for a long time and does not have to be explained further.

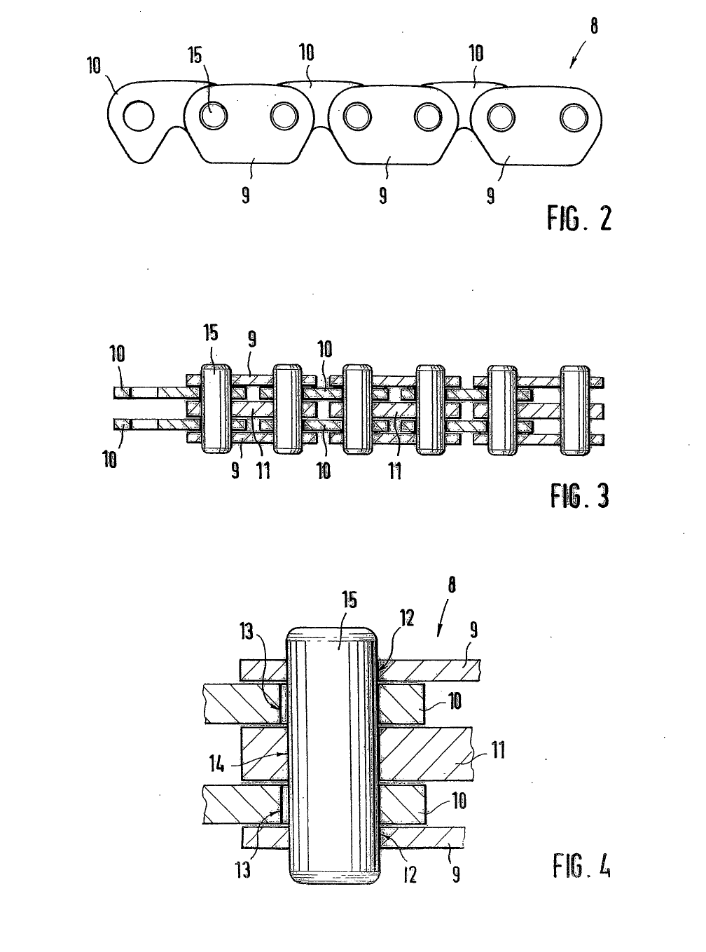

FIG. 2 shows a cutout of a chain or toothed chain 8 that can be used in the chain drive 1, in which it can involve, for example, according to the construction according to the German Patent Application DE 10 2005 024 747 A1, an inverted toothed chain. This is made from lateral guide links 9, which lie on the outside and following which, in the shown embodiment, there are two pivot links 10, between which, in turn, a connection link 11 is arranged. As is to be taken from the section view according to FIG. 3, the outer guide links 9 and the middle connection link 11 are essentially congruent with each other, while the pivot links 10 are offset relative to the others. The links have corresponding connection apertures 12 (on the guide links 9), 13 (on the pivot links 10), and 14 (on the connection link 11). The aligned connection apertures 12, 13, and 14 are penetrated by a connection element 15 in the form of a connection bolt or connection pin. This is relatively thick for improving the wear resistance and for preventing bending. While the spacing and the diameter of each connection aperture 12 of the guide links 9 and the connection aperture 14 of the connection link 11 can be selected in such a way that both sit on the connection element 15 with an interference fit, so that they cannot pivot, it is possible to select the diameter of the connection apertures 13 of the pivot links 10 somewhat larger, so that they are held in a clearance fit on the connection element 15. Here, the spacing can be selected somewhat smaller, so that the inner wall contacts a point on the connection element 15. A corresponding construction is shown in the enlarged detail view in FIG. 4, from which it is visible that the two pivot links 10 and the connection link 11 are significantly wider than the guide links 9, preferably twice as wide, in order to realize the largest possible tooth contact surface, which is especially possible then at a considerable degree, when the connection link 11—following the teaching according to DE 10 2005 024 747— is also provided with a toothed profile. Preferably, the pivot links 10 and the connection link 11 have somewhat different thicknesses and outer contours, so that the parts can be easily sorted for assembly.

In the chain 8 made following the teaching according to the invention for use in the chain drive according to the invention, now all of the connection apertures 12, 13, 14 of all of the links 9, 10, and 11 are normally punched. A normally punched connection aperture is distinguished by a flush-cut percentage ≦80% and can be produced in a significantly easier way than the fine-punched connection aperture having a flush-cut percentage >80%.

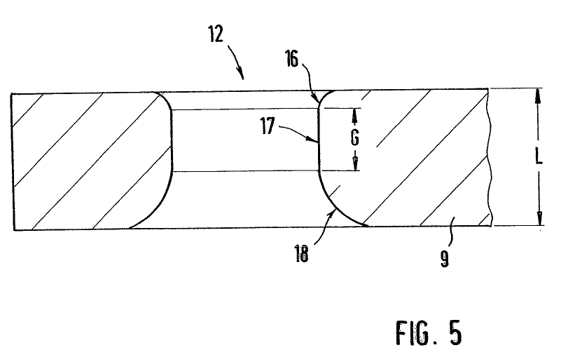

FIG. 5 makes it clear how each flush-cut percentage is produced. As an example, a cutout from a guide link 9 with the connection aperture 12 is shown, wherein the subsequent constructions obviously apply identically for the links 10 and 11 and their connection apertures 13 and 14.

Over its length extending perpendicular to the link 9, the connection aperture 12 can be divided into three sections, namely the first cut 16, the flush cut 17, and the pull-out cut 18. The flush cut 17 is understood to be the region, in which the connection aperture 12 has a homogeneous, cylindrical wall and does not change in diameter.

The flush-cut percentage is calculated as
Flush-cut percentage=(G/L)×100%.

Here, G is the length of the flush cut 17, see FIG. 5, while L describes the link thickness, see FIG. 5. For a normally punched connection aperture, the calculated flush-cut percentage equals ≦80%, while the flush-cut percentage for a fine-punched connection aperture is >80%. The greater the flush-cut percentage is, the greater the contact surface of each connection aperture on the connection element 15 and consequently the force transmission surface. For the chain used according to the invention, however, each of the connection apertures 12, 13, 14 is normally punched, thus they have a flush-cut percentage ≦80%. Nevertheless, the force oscillations still given or even the forces to be transmitted can be absorbed or transmitted by the chain.

### REFERENCE NUMBERS

1 Chain drive
2 Crankshaft
3 Sprocket
4 Camshaft
5 Camshaft
6 Sprocket
7 Sprocket
8 Chain
9 Guide link
10 Pivot link
11 Connection link
12 Connection aperture
13 Connection aperture
14 Connection aperture
15 Connection element
16 First cut
17 Flush cut
18 Pull-out cut

1. Chain drive comprising several shafts integrated into the drive, each of the shafts having a sprocket, and a chain guided over the sprockets, wherein at least one of the sprockets has a non-round shape for reducing chain forces resulting from disturbance vibrations introduced into the drive the chain is comprised of links, which are connected to each other via pin-like connection elements and all of the links have connection apertures that are normally punched.

2. Chain drive according to claim 1, wherein the chain has, at each of the connection elements, three of the links, which lie one next to the other and a middle one of the links has tooth-like profiling for a force-transmitting engagement on the toothed sprocket.

3. Chain drive according to claim 1, wherein the chain has, at each of the connection elements, five or more of the links lying one next to the other, with two outer guide links, followed by at least two pivot links with tooth-like profiling for a force-transmitting engagement on the toothed sprocket and between the pivot links is at least one connection link.

4. (canceled)

5. (canceled)

6. Chain drive according to claim 1, wherein a flush cut percentage of the normally punched connection apertures is <80%.
